(19) United States
(12) Patent Application Publication
(10) Pub. No.: US 2022/0138650 A1
(43) Pub. Date: May 5, 2022

(54) Determining and Improving an Organization's Effectiveness

(71) Applicant: Health Policy Advocates, LLC, Houston, TX (US)

(72) Inventor: Rekha Lakshmanan, Houston, TX (US)

(73) Assignee: Health Policy Advocates, LLC, Houston, TX (US)

(21) Appl. No.: 17/519,431

(22) Filed: Nov. 4, 2021

Related U.S. Application Data
(60) Provisional application No. 63/109,826, filed on Nov. 4, 2020.

(51) Int. Cl. G06Q 10/06; G06Q 30/02

(52) U.S. Cl. CPC G06Q 10/0637; G06Q 30/0203

(57) ABSTRACT

A system, method, and storage device including a system for determining an organization's mission effectiveness score (MES) based at least upon surveying one or more stakeholders and determine, for the organization, effectiveness factor scores for a set of one or more effectiveness factors based at least upon surveying one or more of the stakeholders. The system also identifies, using a processor, one or more relationships between the organization's MES score and the one or more effectiveness factor scores based at least upon correlations between industry MES scores and industry effectiveness factor scores.

### A. PRIORITY CLAIM/INCORPORATION BY REFERENCE

This application claims the benefit of U.S. Provisional Application No. 63/109,826, filed 4 Nov. 2020, entitled “Determining and Improving Effectiveness Score,” and naming Rekha Lakshmanan as inventor. The above-referenced provisional patent application is hereby incorporated by reference herein in its entirety.

### B. BACKGROUND

The invention relates generally to methods, systems, and devices for determining and improving the effectiveness of nonprofit organizations.

### C. BRIEF DESCRIPTION OF THE DRAWINGS

Other objects and advantages of the invention may become apparent upon reading the detailed description and upon reference to the accompanying drawings.

FIG. 1 is a block diagram of various access devices that display and receive answers to survey questions, in accordance with some embodiments.

FIG. 2 is a flowchart for determining an MES score and drivers' scores and their correlation to industry scores, in accordance with some embodiments.

FIG. 3 is a flowchart for determining Industry Mission Effectiveness Score and Organization Mission Effectiveness Score, in accordance with some embodiments.

FIG. 4 is a flowchart for determining correlations between stakeholder survey responses and industry MES scores in accordance, in accordance with some embodiments.

FIG. 5 is a flowchart for improving organization MES score, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

Disclosed below are various concepts related to, and embodiments of, systems and methods for automatically detecting similarities between sensors in order to identify and match sensors of a similar nature and type.

Certain terms are used throughout the following description section and claims section to refer to particular system components and configurations. As one skilled in the art will appreciate, the same component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

The foregoing description of the figures is provided for convenience. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. The same or similar parts may be marked with the same or similar reference numerals.

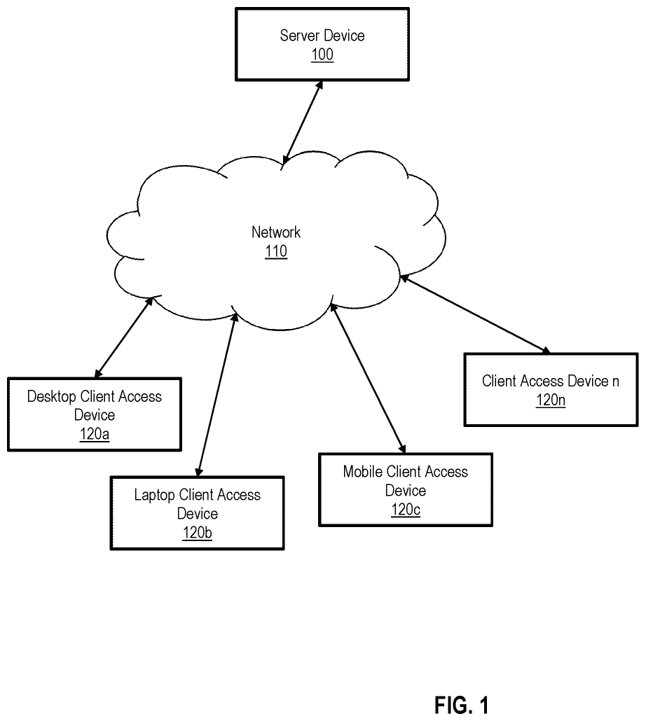

FIG. 1 is a block diagram of various access devices that display and receive answers to survey questions, in accordance with some embodiments.

In some embodiments, the system illustrated in FIG. 1 is configured to determine and to improve the mission effectiveness score for an organization. Server device 100 is connected, either directly or indirectly, to client access devices 120a to 120n via network 110. In accordance with various embodiments, client access devices 120 may be desktop client access device 120a, laptop client access device 120b, mobile client access device 120c, and client access device N.

Network 110, in accordance with various embodiments, may include one or more of the following: a direct or indirect physical communication connection, mobile communication network, Internet, intranet, Local Area Network, Wide Area Network, Storage Area Network, and any other forms of connecting two or more systems or storage devices together. In some embodiments, clients 120 access data and/or services provided by server device 100 and provide information to server device 100 via network 110. For example, a user utilizes mobile client access device 120c to access an internet website at east in part provided by server device 100. The internet website enables the user to provide information required to determine a mission effectiveness score, for example. The website may also provide to mobile client access device 120c tools, feedback, and information for a user of mobile client access device 120c to improve and/or maintain theft organization's mission effectiveness score.

Any number of server devices 100 and client access devices 120 may be connected to network 110. Mobile client access device 120c may access a plurality of server devices 100 connected to network 110 to provide and/or obtain information related to the mission effectiveness score. Any number of client access devices 120 may access one or more server devices, such as server device 100, via network 110, to determine and/or interact with a mission effectiveness score. In various embodiments, server device 100 is connected to a storage, such as a database, that stores information associated with survey questions and other metrics (e.g., user provided information, mission effectiveness score(s), survey questions and answers, actions to improve a mission effectiveness score, effectiveness metrics, etc.) of one or more organizations.

The systems and methods described in flowcharts below may be implemented on a particular machine with sufficient processing power, memory resources, and network throughput capability to handle the necessary workload placed upon it.

As discussed with reference to FIG. 1, server device 100 is suitable for implementing one or more embodiments disclosed herein. Although not shown in FIG. 1, the particular server machine 100 includes at least one processor (which may be referred to as a central processing unit or CPU) that is in communication with a non-transitory machine-readable medium, which may be a non-transitory computer-readable medium and/or storage device. The machine-readable medium may comprise memory devices including secondary storage, read only memory (ROM), and random access memory (RAM). The processor is further in communication with input/output (I/O) devices and network connectivity devices, and the processor may be implemented as one or more CPU chips.

Although not shown in FIG. 1, the secondary storage may be comprised of one or more disk drives and is used for non-volatile storage of data and may be used as an over-flow data storage device if RAM is not large enough to hold working data. Secondary storage may be used to store instructions or programs that are loaded into RAM when such instructions or programs are selected for execution and cause the processor to perform any of the steps/blocks described in this disclosure. ROM may also be used to store instructions or programs and may be used to store data for reading during program execution. ROM is a non-volatile memory device which typically has a small memory capacity relative to the larger memory capacity of secondary storage. RAM is used to store volatile data and may also be used to store programs or instructions. Access to both ROM and RAM is typically faster than to secondary storage.

Though not shown coupled to server device 100 of FIG. 1, I/O devices may include printers, monitors, touch screens, keyboards, keypads, switches, dials, mice, voice recognizers, card readers, tape readers, or other input devices. Network connectivity devices may include modems, modem banks, Ethernet cards, universal serial bus (USB) cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other network devices. These network connectivity devices may enable the processor in server device 100 to communicate with the Internet or one or more intranets. With such a network connection, the processor may receive information from the network 110, or may output information to the network, in the course of performing the above-described method steps/blocks.

The processor executes codes, computer programs, scripts which it accesses from hard disk, floppy disk, optical disc (these various disk-based systems may be considered secondary storage), ROM, RAM, or the network connectivity devices.

In accordance with some embodiments, FIG. 1 illustrates a system comprising a non-transitory machine-readable medium or computer-readable medium storing software that, when executed by one or more processors (not shown) in server device 100 and client access device 120, causes the one or more processors to perform or initiate any of the steps/blocks described in this disclosure.

In some embodiments, the mission effectiveness score may be implemented with a mission effectiveness score analysis and ranking (MESAR) application. The MESAR application may be used to collect information from stakeholders and other experts in the field related to the internal and external operations of the organization. Examples questions, or effectiveness factors, may include:

1. How frequently does your organization receive private funding (eg., foundations) to support the organization's advocacy and policy work?

2. What percentage of your overall budget is dedicated to your organization's advocacy and policy work?

3. How likely will the media (local and state) contact your organization as a subject matter expert?

4. How frequently do lawmakers and their staff contact your organization for advice about your subject to help inform their policy decisions?

5. Does your organization proactively draft legislation?

6. Does your organization use a contract lobbyist to help advance policy initiatives?

7. Does your organization have dedicated paid staff to advance your organization's advocacy and policy work?

Questions 1-7 are example questions and in various embodiments are not limited or similar to such questions in form, substance and number of questions. The MESAR application requests the stakeholder/expert to input written answers to each question given above for their organization. In accordance with various embodiments, the MESAR application may provide a free form text field for the stakeholder to answer the question, a set of multiple-choice answers, a scale allowing the user to select a number from 0 to 10 (e.g., 0 least effective, 10 most effective), or other methods to answer each question.

In some embodiments, the stakeholder may be asked an additional question 8:

8. On a scale of 0 to 10 with 10 being the most effective, what is the effectiveness of your associated organization in achieving its mission?

In some embodiments, the stakeholder may select a sliding scale answer from 0 to 10 for this MES question.

In accordance with some embodiments, the stakeholder may be asked a further series of survey questions 9 through 12 (additional examples of effectiveness factors) about internal and external operations of their organization:

9. How often does your organization revisit and adjust its advocacy tactics to match the environment you are operating in?

10. How frequently does your organization build coalitions to advance your advocacy and policy work?

11. Does your organization have community activists to support and amplify your organization's advocacy and policy work?

12. How often does your organization evaluate and evolve its public messaging to support your advocacy and policy work?

Questions 9-12 are example questions and in various embodiments are not limited or similar to such questions in form, substance, and number of questions. Similar to the questions 1-8 above, the MESAR application requests the stakeholder to input written answers to each question 9-12 for their organization. In accordance with various embodiments, the MESAR application may provide a free form text field for the stakeholder to answer the question, a set of multiple-choice answers, a scale allowing the user to select a number from 0 to 10 (e.g., 0 least effective, 10 most effective), or other techniques to answer each question. The questions described above may allow correlation of the calculated industry MES scores described in detail below with the stakeholder responses to survey questions 1-12. The order of questions, wording of each question, number of questions, and methods to answer each question varies in different embodiments and does not affect the correlation of the calculated industry MES scores.

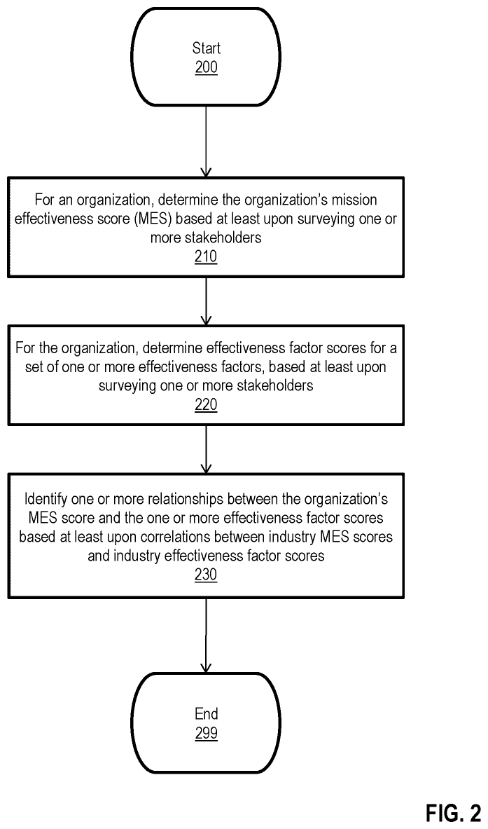

FIG. 2 is a flowchart for determining an MES score and drivers' scores and their correlation to industry scores, in accordance with some embodiments.

Measuring the effectiveness of nonprofit organizations can be a difficult task. Nonprofit organizations that engage in advocacy generally see the results of their advocacy efforts after many months or years. The results of the nonprofits advocacy may be either the passage of new legislation or, in some instances, preventing the passage of bad legislation. External stakeholders (e.g., foundations, funders, trade associations, corporations, and so on) that provide financial support to nonprofit advocacy organizations may view incremental outcomes after long periods of time as ineffective because the results are difficult to quantify and a basis of comparison between different organizations does not exist. Internal stakeholders such as organizational officers and Board of Directors may be unaware of their organization's effectiveness and reputation as compared to their peers. Because of the difficulties in quantifying their effectiveness, the nonprofit organization may not know what effectiveness factors influence or impact their effectiveness or be able to determine how to improve their effectiveness over a period of time or how they compare to peers in their industry.

Upon start 200, at block 210, for an organization, the organization's mission effectiveness score (MES) is determined based at least upon surveying one or more stakeholders of the organization.

At block 220, for the organization, effectiveness factor scores for a set of one or more effectiveness factors are determined, based at least upon surveying one or more stakeholders.

At block 230, one or more relationships are identified between the organization's MES score and the one or more effectiveness factor scores based at least upon correlations between industry MES scores and industry effectiveness factor scores.

The process ends at 299

Nonprofit organizations engaged in advocacy may use the Mission Effectiveness Score of their organization to measure the effectiveness of their work in achieving their mission. This score allows the nonprofit's officers, board members, and managers to measure the nonprofit's effectiveness over time. Thus, the organization MES gives stakeholders a quantified understanding of effectiveness and growth. Stakeholders can also view the Mission Effectiveness Score for their industry that is the global average score of participating organizations in their industry.

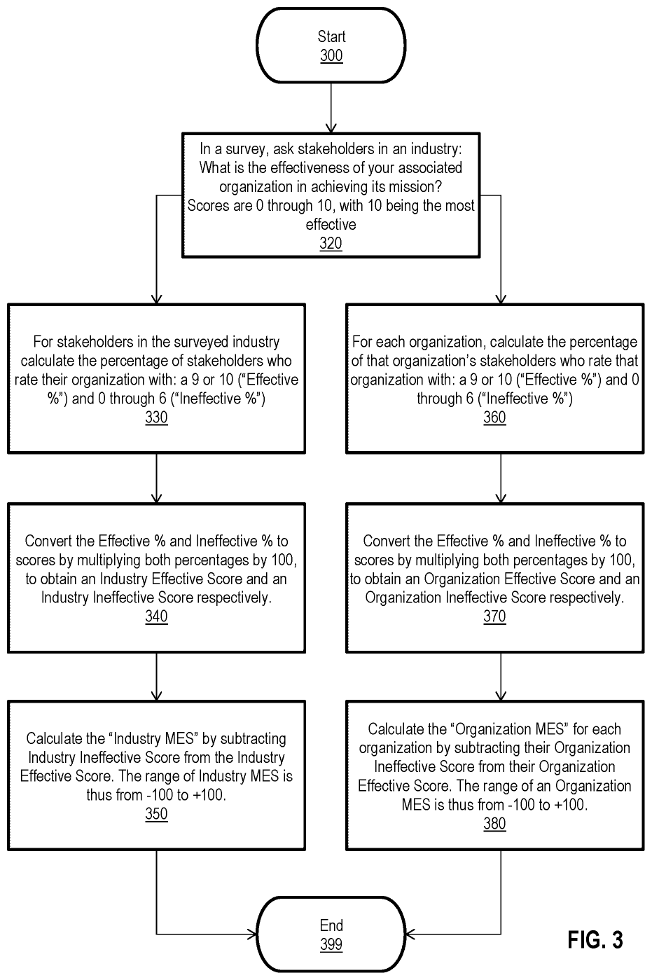

FIG. 3 is a flowchart for determining Industry Mission Effectiveness Score and Organization Mission Effectiveness Score, in accordance with some embodiments.

Upon start 300, the stakeholders of a nonprofit advocacy organization, for example, take a survey on one of client access devices 120a to 120n. In block 320, answers to question 8 (above) “What is the effectiveness of your associated organization in achieving its mission?” are answered by stakeholders in an industry. In accordance with some embodiments, the industry may be nonprofit advocacy organizations or other types of nonprofit organizations or generally other organizations. Blocks 330, 340, and 350 receive the data collected for question 8 (an example of which was given above) and determine an industry mission effectiveness score. Simultaneously, blocks 360, 370, and 380 receive the data collected for question 8 and determine, for each organization, an organization mission effectiveness score. As described in accordance with FIG. 1, the data collected in block 320 from client access devices 120 may be communicated through network 110 to server device 100 that uses the data to perform blocks 330-380 and determine the industry mission effectiveness score and the organization mission effectiveness score.

In accordance with some embodiments, in block 330, for stakeholders in the surveyed industry, the percentage of stakeholders who rate their organization with a 9 or 10 (“Effective percentage”) and 0 through 6 (“Ineffective percentage”) is calculated. In block 340, the Effective percentage and the Ineffective percentage is converted to scores by multiplying both percentages by 100 to obtain an Industry Effective Score and an Industry Ineffective Score, respectively. Finally, in block 350, the Industry Mission Effective Score (Industry MES) is calculated by subtracting the Industry Ineffective Score from the Industry Effective Score. The range of Industry MES is thus from negative 100 to positive 100 when this method is used for the calculation.

In accordance with some embodiments, in block 360, for each organization, the percentage of that organization's stakeholders who rate that organization with a 9 or 10 (“Effective percentage”) and 0 through 6 (“Ineffective percentage”) is calculated. In block 370, the Effective percentage and the Ineffective percentage is converted to scores by multiplying both percentages by 100 to obtain an Organization Effective Score and an Organization Ineffective Score, respectively. Finally, in block 380, the Organization Mission Effective Score (Organization MES) for each organization is calculated by subtracting the Organization Ineffective Score from the Organization Effective Score. The range of Organization MES is thus from negative 100 to positive 100. The flowchart branches end in block 399.

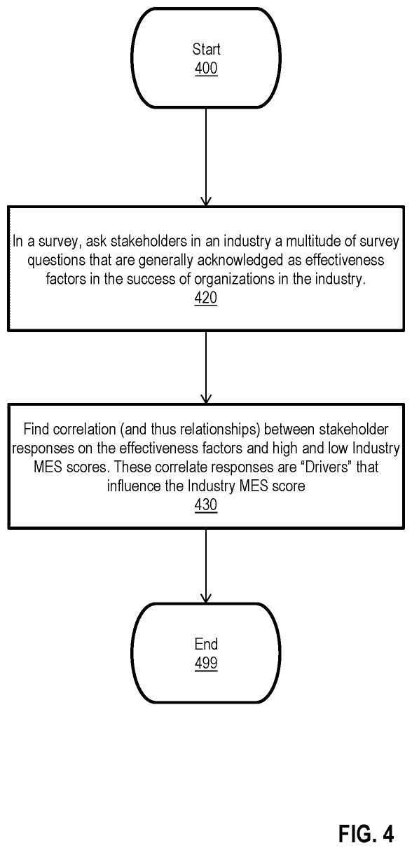

FIG. 4 is a flowchart for determining correlations between stakeholder survey responses and industry MES scores in accordance, in accordance with some embodiments.

In accordance with some embodiments, a flowchart for determining correlations between stakeholder survey responses and Industry MES scores is illustrated. After starting at block 400, at block 420, stakeholders (and more generally experts) in an industry that, in some embodiments, includes nonprofit advocacy organizations, answer a plurality of survey questions that are generally acknowledged as effectiveness factors in the success of organizations in the industry. Stakeholders perform this survey on client access devices 120a to 120n as illustrated in FIG. 1, for example. In accordance with some embodiments, the survey questions include questions such as example questions 1-12 described above.

Next, in block 430, the correlation/relationships between stakeholder responses on the effectiveness factors and Industry MES scores is determined. Various statistical methods may be used in calculating the correlations. Certain survey responses on the effectiveness scores are “drivers” that influence and correlate to the industry MES score. These drivers may have a positive correlation or a negative correlation with the Industry MES score. In some embodiments, based at least on the correlation results, the impact of drivers on the MES score of an organization is identified. Driver with high correlation of improved MES scores may then pursued by an organization to improve the organization's MES score.

After determining the correlation, the flowchart ends in block 499.

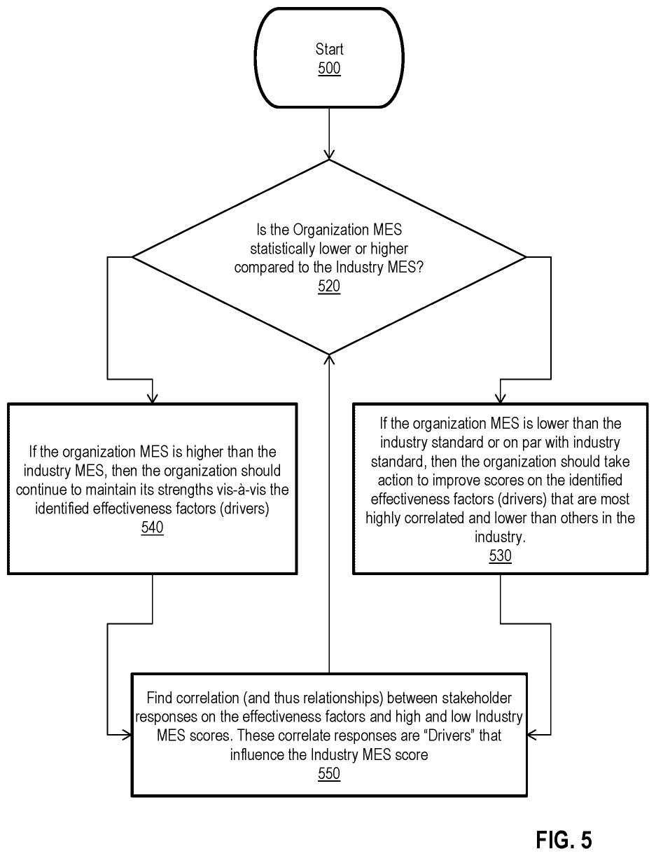

FIG. 5 is a flowchart for improving organization MES score, in accordance with some embodiments.

A flowchart for improving organization MES score in accordance with at least some illustrative embodiments is shown. The flowchart starts at block 500 but has no stop block as it is periodically reevaluating the Organization MES score 550 in a feedback loop.

In block 520, a determination is made if the Organization MES is statistically higher, lower, or the same compared to the Industry MES. If the Organization MES is higher than Industry MES, then flow goes to block 530 in which the Nonprofit Organization is advised to continue to maintain its strengths vis-à-vis the Drivers (identified effectiveness factors).

If the Organization MES is lower than the Industry MES or on par with Industry MES, then flow continues in block 540 in which the Nonprofit Organization is advised to take action to improve scores on the Drivers that are most highly correlated with higher MES scores in the industry.

Finally, in block 550, after a period of time, the Organization MES score is re-assessed against current Industry MES scores (with the correlations and relationships reassessed) and the flowchart returns to block 520. In accordance with some embodiments, as shown in the figure, the period may be one year (or any other appropriate period), for example.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method comprising:
determining an organization's mission effectiveness score (MES) based at least upon surveying one or more stakeholders;
determining, for the organization, effectiveness factor scores for a set of one or more effectiveness factors based at least upon surveying one or more of the stakeholders;
identifying, using a processor, one or more relationships between the organization's MES score and the one or more effectiveness factors based at least upon correlations between industry MES scores and industry effectiveness factor scores.

2. The method of claim 1, wherein identifying the one or more relationships comprises identifying which of the one or more effectiveness factors have a highest impact on increasing or decreasing the organization's MES score.

3. The method of claim 1, wherein determining the MES score is based at least upon asking the stakeholders to choose a number from 0 to 10 representing the effectiveness of the organization in achieving its mission.

4. The method of claim 1, the identifying comprises identifying which of the one or more effectiveness factors to change to improve the organization's MES score.

5. The method of claim 1, comprising re-determining the organization's MES score again after a certain period based at least on the identifying the one or more relationships.

6. The method of claim 1, comprising re-determining the organization's effectiveness factor scores again after a certain period based at least on the identifying the one or more relationships.

7. A non-transitory computer-readable storage device comprising instructions that, when executed, cause one or more processors to:
determine an organization's mission effectiveness score (MES) based at least upon surveying one or more stakeholders;
determine, for the organization, effectiveness factor scores for a set of one or more effectiveness factors based at least upon surveying one or more of the stakeholders;
identify, using a processor, one or more relationships between the organization's MES score and the one or more effectiveness factors based at least upon correlations between industry MES scores and industry effectiveness factor scores.

8. The storage device of claim 7, wherein identifying the one or more relationships comprises identifying which of the one or more effectiveness factors have a highest impact on increasing or decreasing the organization's MES score.

9. The storage device of claim 7, wherein determining the MES score is based at least upon asking the stakeholders to choose a number from 0 to 10 representing the effectiveness of the organization in achieving its mission.

10. The storage device of claim 7, the identifying comprises identifying which of the one or more effectiveness factors to change to improve the organization's MES score.

11. The storage device of claim 7, comprising re-determining the organization's MES score again after a certain period based at least on the identifying the one or more relationships.

12. The storage device of claim 7, comprising re-determining the organization's effectiveness factor scores again after a certain period based at least on the identifying the one or more relationships.

13. A system comprising:
one or more processors;
memory coupled to the one or more processors;
the memory comprising executable instructions that, when executed, cause the one or more processors to:
determine an organization's mission effectiveness score (MES) based at least upon surveying one or more stakeholders;
determine, for the organization, effectiveness factor scores for a set of one or more effectiveness factors based at least upon surveying one or more of the stakeholders;
identify, using a processor, one or more relationships between the organization's MES score and the one or more effectiveness factors based at least upon correlations between industry MES scores and industry effectiveness factor scores.

14. The system of claim 13, wherein identifying the one or more relationships comprises identifying which of the one or more effectiveness factors have a highest impact on increasing or decreasing the organization's MES score.

15. The system of claim 13, wherein determining the MES score is based at least upon asking the stakeholders to choose a number from 0 to 10 representing the effectiveness of the organization in achieving its mission.

16. The system of claim 13, the identifying comprises identifying which of the one or more effectiveness factors to change to improve the organization's MES score.

17. The system of claim 13, comprising re-determining the organization's MES score again after a certain period based at least on the identifying the one or more relationships.

18. The system of claim 13, comprising re-determining the organization's effectiveness factor scores again after a certain period based at least on the identifying the one or more relationships.
